(19) United States
(12) Patent Application Publication
(10) Pub. No.: US 2012/0089593 A1
(43) Pub. Date: Apr. 12, 2012

(54) QUERY OPTIMIZATION BASED ON REPORTING SPECIFICATIONS

(76) Inventor: SHIV PRATAP SINGH, Bangalore (IN)

(21) Appl. No.: 12/901,580

(22) Filed: Oct. 11, 2010

(51) Int. Cl. G06F 17/30

(52) U.S. Cl. 707/713; 707/792; 707/E17.131; 707/E17.055

(57) ABSTRACT

Various embodiments of systems and methods for query optimization based on reporting specifications are described herein. A plurality of data provider objects are categorized into one or more used data provider objects that are used in a report at a first instance and one or more unused data provider objects that are not used in the report at the first instance. The plurality of data provider objects is part of a query. A modified query is then created by excluding the unused data provider objects. Data of the used data provider objects is retrieved and stored in a local data source using the modified query. The unused data provider objects are displayed such that they are differentiated from the used data provider objects and can be selected for use in the report at the second instance.

### FIELD

The field relates generally to querying techniques. More particularly, the field is related to a query stripping technique that optimizes queries based on reporting and analysis requirements to improve computational performance.

### BACKGROUND

Business Intelligence broadly refers to a category of software systems and applications used by business enterprises to analyze, report, and leverage data. Business Intelligence tools such as reporting and analysis tools can be used to analyze and present information. These tools use data retrieved from multiple data sources and can integrate the data into a report to facilitate analysis of the retrieved data. ‘Report’ may refer to information retrieved (e.g., in response to computer executable instructions) from a data source (e.g., a database, a data warehouse). The data may be transformed and formatted per a template or a schema for the report.

Retrieving data for analysis may require multiple queries to multiple data sources. A report document specifies how to access and format data. Unlike other non-report documents (e.g. word processor document, presentation document) that may optionally import external data within a document, a report document by design is primarily a medium for accessing and formatting, transforming or presenting external data. A report is designed to facilitate working with external data sources. In addition to information regarding external data source connection drivers, the report may specify advanced filtering of data, information for combining data from different external data sources, information for updating join structures and relationships in report data, and logic to support a more complex internal data model.

For Business Intelligence tools that include ad hoc query and reporting, queries are authored by domain knowledge or power users and reports are created by consumers or secondary users using these queries. As the query author and the consumer are generally different users, queries are usually created with more data objects than required for the tools. A power user has the rights to modify or edit queries. The secondary users, however, generally do not have the right to edit the queries. But the secondary users can create reports with a subset of data objects. Therefore, if a secondary user desires to generate a report listing only a subset of the data objects, other data objects may still be queried and included in the report. In effect, data that is not actually consumed in report is also fetched, burdening databases and increasing querying time. The unused data objects increase the size of the report and create an overhead to databases.

It would therefore be desirable to optimize queries for fetching data that would be directly consumed in the report.

### SUMMARY

Various embodiments of systems and methods for query optimization based on reporting specifications are described herein. A plurality of data provider objects, which are part of a query, are categorized into one or more used data provider objects that are used in a report at a first instance and one or more unused data provider objects that are not used in the report at the first instance. A modified query is then created by excluding the unused data provider objects. Data of the used data provider objects is retrieved and stored in a local data source using the modified query. The unused data provider objects are displayed such that they are differentiated from the used data provider objects and can be selected for use in the report at the second instance.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a method for optimizing queries, according to one embodiment.

FIG. 2 is a block diagram illustrating a method for optimizing queries, according to another embodiment.

FIG. 3 is a block diagram illustrating the categorization of data provider objects, according to one embodiment.

FIG. 4 is a block diagram illustrating the usage of different data provider objects for reports, according to one embodiment.

FIG. 5 is a block diagram illustrating a framework for the method for optimizing queries, according to one embodiment.

FIG. 6 is a block diagram illustrating an exemplary user interface with used and unused data provider objects, according to one embodiment.

FIGS. 7 and 8 are block diagrams illustrating exemplary interfaces where a previously unused data provider object is used in a report, according to one embodiment.

FIG. 9 is a block diagram of an exemplary computer system according to one embodiment.

### DETAILED DESCRIPTION

Embodiments of techniques for query optimization based on reporting specifications are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

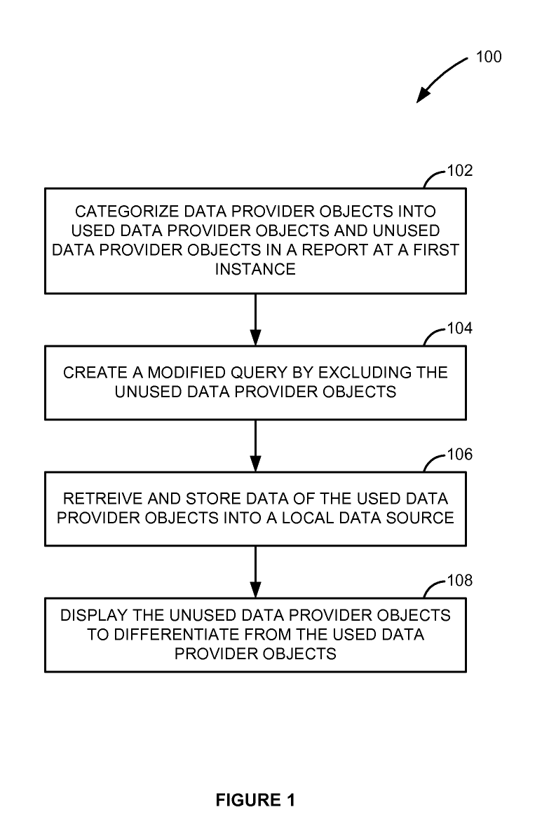

FIG. 1 illustrates a method 100 of optimizing queries according to one embodiment. In one embodiment, the method is used in Business Intelligence Query and Reporting applications (e.g. SAP Business Objects applications). The query and reporting applications are used to generate reports using queries. A query is typically created by domain knowledge users using a plurality of data provider objects. Data Provider (DP) objects are subset of data source objects. In one embodiment, data source is a semantic layer (e.g. universe for Business Objects). The data source objects in the semantic layer are in turn mapped to attributes in database tables. A user interface is provided for reporting applications and the data provider objects that are part of a query are displayed on the user interface. A secondary user or a developer user can select combinations of these data provider objects to generate reports.

A report can evolve over a period of time and reporting specifications can vary. For example, the secondary user may use only a subset of the data provider objects to generate a report at a first instance (e.g. report 1). The number of data provider objects used in the report depends on the need of the user. At 102, the plurality of data provider objects are categorized into used data provider objects and unused data provider objects. The used data provider objects are the data provider objects that are used in the report at the first instance. The unused data provider objects are not used in the report at the first instance. Both the used and unused data provider objects are part of the query created by the domain knowledge user. In one embodiment, the query is an initial query that is created by the domain knowledge user. This initial query is un-editable by secondary users. The secondary users cannot edit the query by deleting any of the data provider objects that are part of the initial query.

At 104, a modified query is created by excluding the unused data provider objects. The modified query only includes the used data provider objects. The unused data provider objects are not included in the modified query. This modified query is used to query an external database. The external data source can be a database where the data related to the data provider objects is stored. By using only the used data provider objects for querying the database, the burden on the database is reduced. At 106, data of the used data provider objects is retrieved from the database and stored in a local data source. This data can be used for various purposes. In one embodiment, the data stored in the local data source can be used to perform analyses. Analysis can be performed by first creating an initial cube with data of the used data provider objects and a dummy value for unused data provider objects. Any operations for the analysis can be performed on the initial cube.

The unused data provider objects may be used in the report at a second instance (e.g. report 2). The report at the second instance can be any report at an instance created subsequent to the report at the first instance. The user may find the need to use an unused data provider object of the report at the first instance. At 108, the unused data provider objects are displayed such that the unused data provider objects are differentiated from the used data provider objects. Both the used and unused data provider objects of the report at the first instance are displayed on the user interface of the reporting application. But the unused data provider objects are highlighted to differentiate them from the used data provider objects. For example, the unused data provider objects can be shown in “bold” font.

The user can select any of the unused data provider objects and include in the report at the second instance. Following which, steps 102, 104, 106, and 108 are repeated. Specifically, the selected unused data provider objects are categorized as used data provider objects along with any data provider objects that are used in both the first and second instances of the report, leading to a new set of used data provider objects for the report at the second instance. This new set of used data provider objects are queried and corresponding data is retrieved and stored in the local data source. Unused data provider objects in the report at the second instance are highlighted. It should be noted that the term “first instance” does not necessarily mean that the report is accessed for the first time. Also, the “second instance” can be any subsequent instance following the “first instance.”

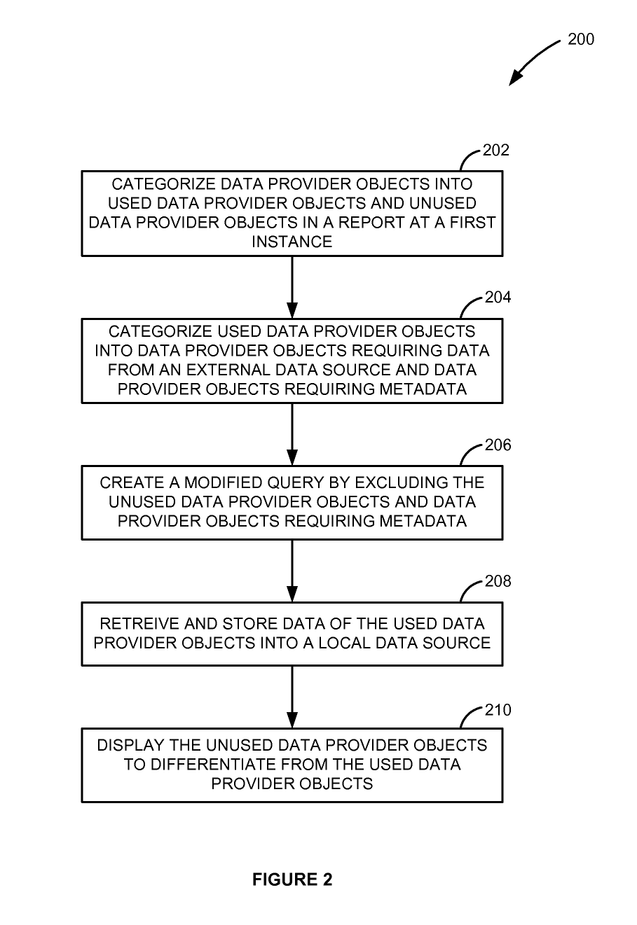

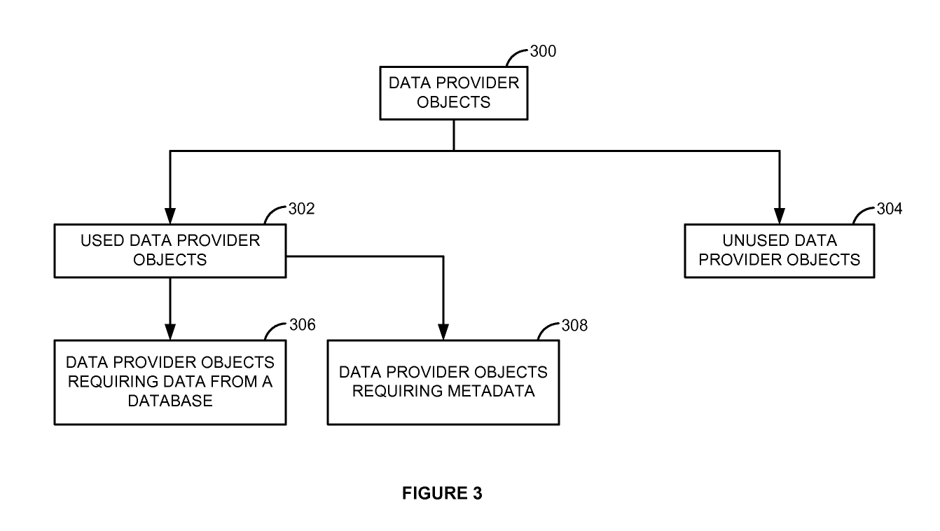

FIG. 2 illustrates another embodiment of the method 200 optimizing queries and FIG. 3 illustrates corresponding categorization of data provider objects 300. In this embodiment, the data provider objects 300 are first categorized into used data provider objects 302 and unused data provider objects 304 at 202. The used data provider objects 302 are further categorized into data provider objects requiring data 306 from an external data source (e.g. a database) and data provider objects requiring metadata 308 at 204. In the process of accessing the reporting application, metadata of the data provider objects 300 is loaded into a local data source. In one embodiment, descriptors of the data provider objects are stored in the local data source. These descriptors include metadata of the data provider objects 300. Some examples of metadata include last execution time of a data provider object and name of a data provider object.

At 206, a modified query is created using only the used data provider objects requiring data 306 from the external data source. The unused data provider objects 304 and data provider objects requiring only metadata 308 are excluded in the modified query. At 208, data of the used data provider objects requiring data 306 is retrieved from the database and stored in a local data source. This data can be used to perform analyses by creating an initial cube for each used data provider object and performing related operations on the initial cube. At 210, the unused data provider objects 304 are displayed to differentiate them from the used data provider objects. In one embodiment, the unused data provider objects 304 are highlighted. This enables the unused data provider objects 304 to be selected and used in the report at the second instance subsequent to the report at the first instance. In one embodiment, the data provider objects requiring only metadata 308 can also be considered as unused data provider objects and highlighted (e.g. bold font) along with the unused data provider objects 304.

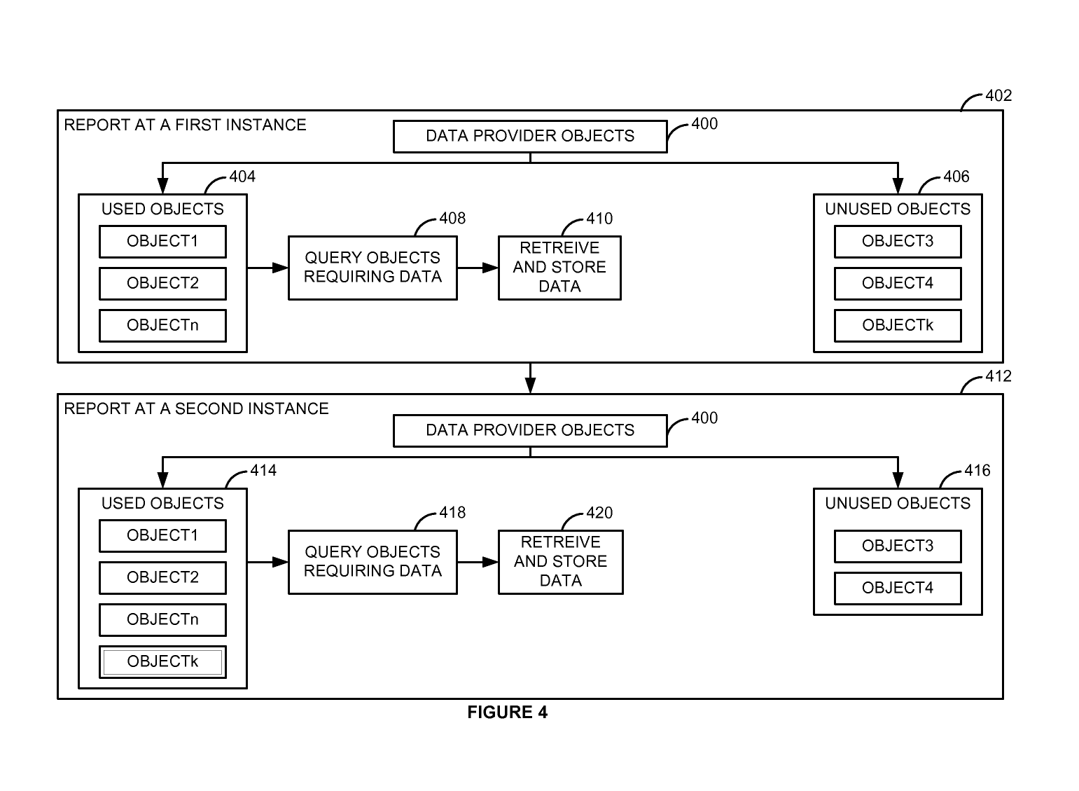

FIG. 4 illustrates usage of data provider objects for reporting applications according to an embodiment of the method of optimizing queries. The initial query includes the following data provider (DP) objects 400: DP Object 1, DP Object 2, DP Object 3, DP Object 4, DP Object n, and DP Object k. Consider that a user only uses DP Objects 1, 2, and n for the report at a first instance 402. Therefore, DP Objects 1, 2, n are categorized as used data provider objects 404 and DP objects 3, 4, k are categorized as unused data provider objects 406. The DP objects 1, 2, n are used for querying a database 408. Data of DP objects 1, 2, n is retrieved and stored 410 in a local data source. At this stage, DP objects 3, 4, k are highlighted, e.g. bolded, in a user interface.

The unused data provider objects 406 can be used in the report at a subsequent instance 412, e.g. second instance. For example, DP object k can be selected for the report at the second instance 408 along with DP objects 1, 2, and n. DP objects 1, 2, n, k are categorized as used data provider objects 414 and DP objects 3 and 4 are categorized as unused data provider objects 416 in the report at the second instance 408. The DP objects 1, 2, n, and k are used for querying a database 418 their corresponding data is retrieved and stored in the local data source 420. At this stage, only DP objects 3 and 4 are highlighted in a user interface.

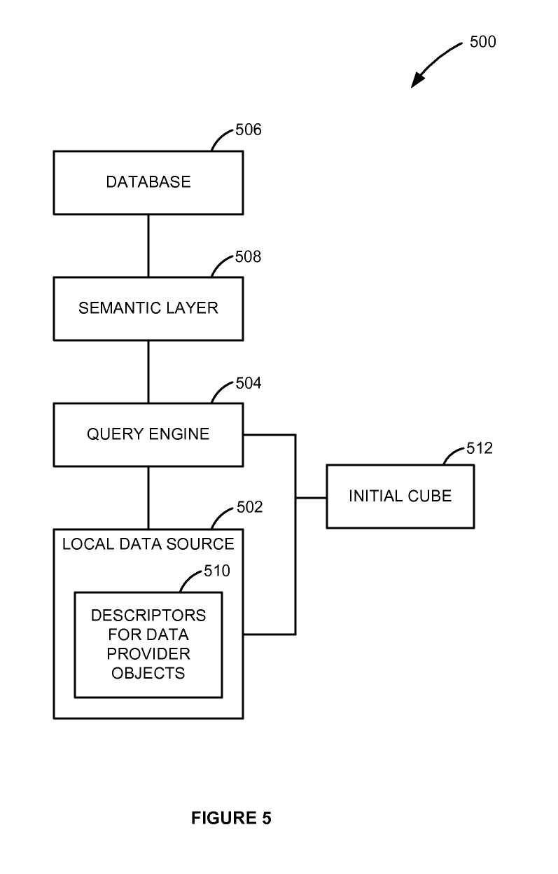

FIG. 5 illustrates a framework 500 for implementing the method of optimizing queries in reporting and analysis applications, according to one embodiment. Initially, a structure of a local data source 502 is created. The structure of the local data source 502 includes data provider objects that are part of an initial query. The structure of the local data source 502 can be referred as a cube structure. A query engine 504 is used to query an external database 506. In one embodiment, queries are routed through a semantic layer 508. Data of the data provider objects is then retrieved from the database 506 and stored in the local data source 502. Descriptors 510 of the data provider objects are also stored in the local data source 502. As mentioned earlier, these descriptors 510 include metadata of the data provider objects.

An initial cube 512 is then created for a report with data provider objects. The initial cube 512 will contain all the data provider objects that are part of the initial query. This initial cube 512 is used as the basis to perform analysis. If an initial query includes the data objects ‘Country,’ ‘City,’ and ‘Revenue’ and if all these data objects are used in the report, an exemplary initial cube can be represented below:

| Country | City | Revenue |
|---|---|---|
| USA | New York | 1000 |
| France | Paris | 950 |
| Germany | Berlin | 900 |

For any given instance of a report the data provider objects in the local data source may be categorized into used data provider objects and unused data provider objects. After the data provider objects are categorized, the query engine 504 queries the database 506 using only the used data provider objects. In other words, the unused data provider objects are stripped from querying. If there are unused data provider objects, the initial cube 512 is created such that it contains all used data provider objects as DP objects and all unused data provider objects as error objects. In one embodiment, the values of these error objects are mapped to ‘#Refresh.’ Taking the above example, if only the ‘Country’ object and ‘Revenue’ object are used, the initial cube can be represented as below:

| Country | City | Revenue |
|---|---|---|
| USA | #Refresh | 1000 |
| France | #Refresh | 950 |
| Germany | #Refresh | 900 |

The size of the above initial cube is reduced because data of the unused data provider object (‘City’ object) is not fetched. This will make calculations, projections, or any other analysis operations faster.

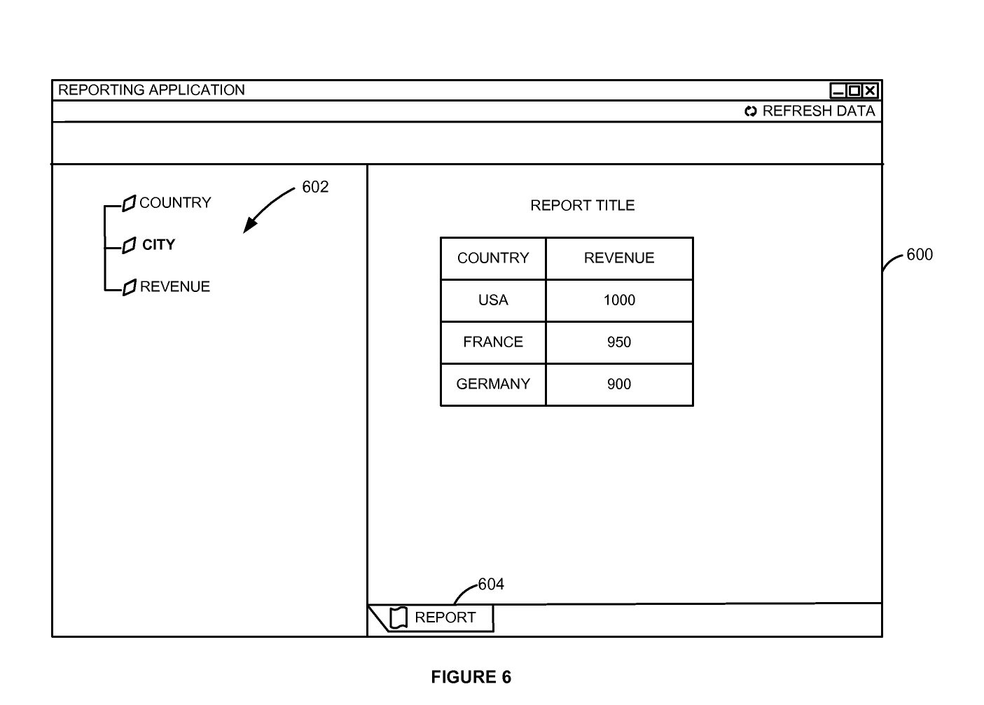

FIG. 6 illustrates an exemplary interface 600 of a reporting application, according to one embodiment. Reports can be generated using an initial or a predefined query, i.e. a query defined by a domain knowledge user using the data provider objects. An example of SQL (initial) query for an RDBMS data source is represented as below:

### INITIAL: SELECT Country, City, Revenue FROM Tablename

Country, city, and revenue are the data provider objects. Similarly, initial queries for other data sources can be defined. For example, a Multi-Dimensional Expressions (MDX) query can be defined for a multidimensional data source, such as, an On-Line Analytical Processing (OLAP) data source.

The data provider objects 602 that are part of the query are displayed on the interface 600. The data provider objects ‘Country’ object, ‘City’ object, and ‘Revenue’ object are used for explanatory purpose. In this example, only ‘Country’ object and ‘Revenue’ object are used in the report at a first instance 604 based on a user selection. The ‘City’ object is not used in the report 604 and therefore highlighted as bold. A user accessing the application can see that ‘Country’ object and ‘Revenue’ object are used in the report 604 and ‘City’ object is not used in the report 604. A modified query is therefore created by excluding the ‘City’ object. A database is queried using only the ‘Country’ object and the ‘Revenue’ object and their respective data is retrieved and stored. An example of a modified SQL query for an RDBMS data source is represented as below:

### MODIFIED: SELECT Country, Revenue FROM Tablename

The stored data can be displayed in the report 604. The ‘City’ object can be referred to as a stripped object as it is not used in querying a database.

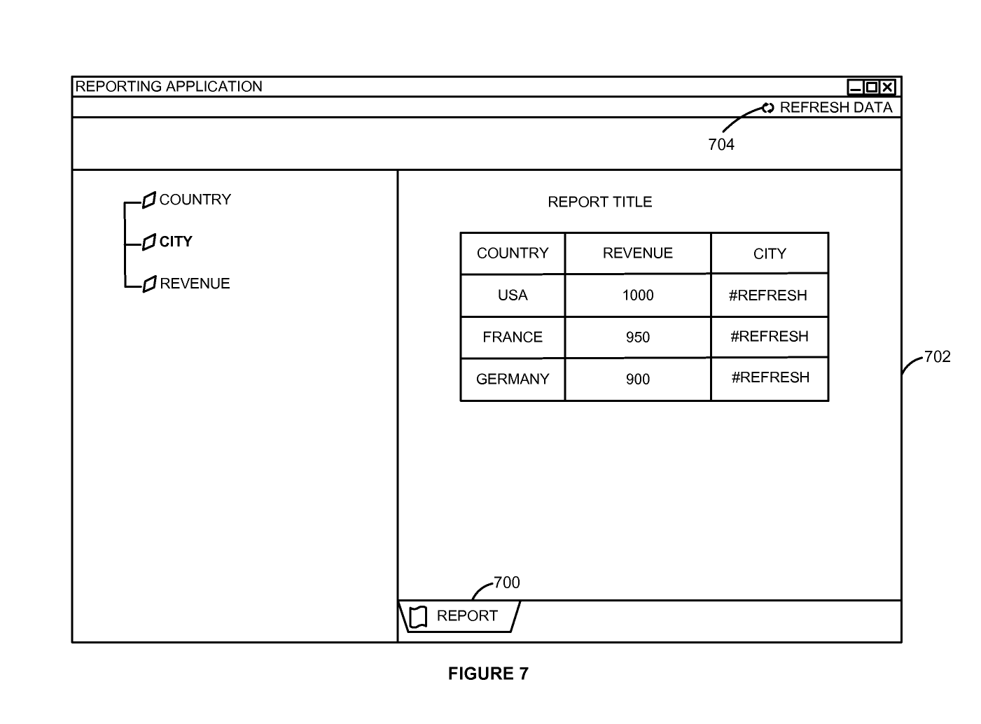

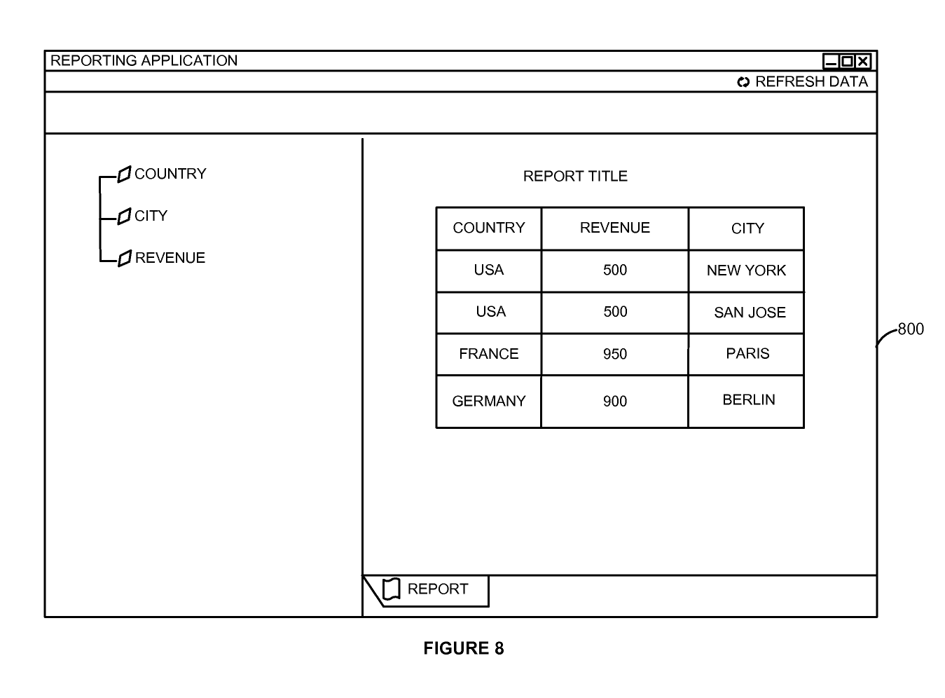

Referring to FIG. 7, the ‘City’ object can be used in the report at a second instance 700 or any instance subsequent to first instance. A user can select the ‘City’ object to include in the report 700 (e.g. by a drag-and-drop operation or by typing). The ‘City’ object is then displayed on the user interface 702 indicating that it is a stripped object, i.e. a previously unused object, and an operation is required to fetch the data of the ‘City’ object. The values of selected unused data provider object, i.e. the ‘City’ object are displayed as dummy values. In one embodiment, “#REFRESH” (a dummy value) is displayed corresponding to the values of the ‘City’ object indicating that a “REFRESH” operation is needed to be performed to fetch the data of the ‘City’ object. The user interface can be provided with a “REFRESH” button 704. Upon clicking the refresh button 704, the local data source is recreated and the data provider objects are again categorized as used data provider objects and unused data provider objects. In this case, ‘Country’ object, ‘City’ object, and ‘Revenue’ object are used data provider objects and there are no unused data provider objects. The selected unused data provider object (‘City’ object) is categorized as the used data provider object along with other used data provider objects (‘Country’ object, ‘Revenue’ object) on the refresh operation. Following which, the database is queried using ‘Country’ object, ‘City’ object, and ‘Revenue’ object and their respective data is retrieved and stored in the local data source. The stored data can be displayed in the user interface 800 as shown in FIG. 8.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

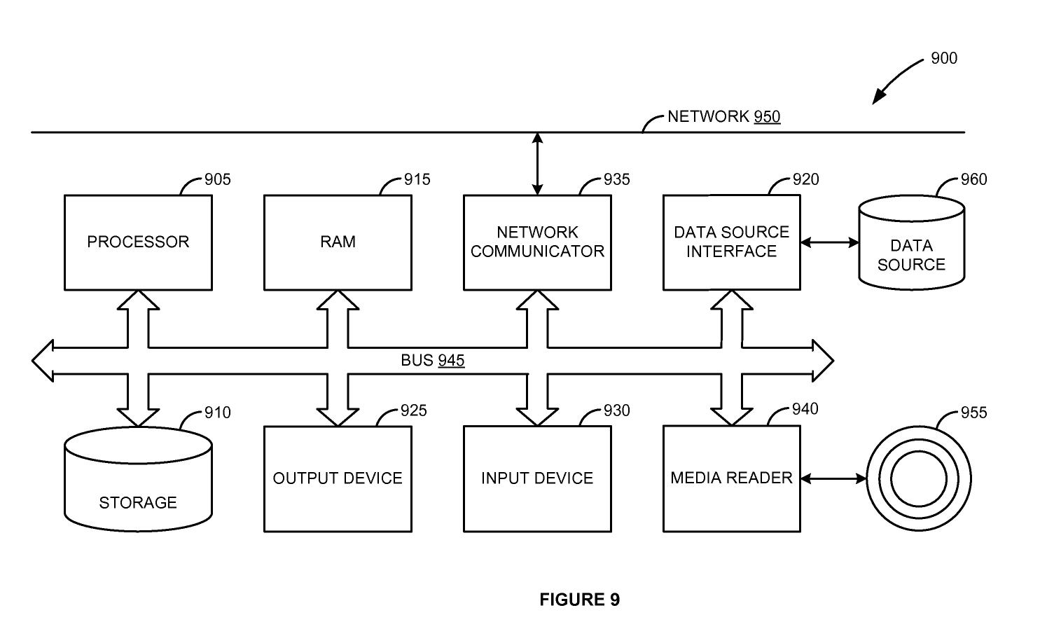

FIG. 9 is a block diagram of an exemplary computer system 900. The computer system 900 includes a processor 905 that executes software instructions or code stored on a computer readable storage medium 955 to perform the above-illustrated methods of the invention. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. The stored instructions may be further compiled to generate other representations of the instructions and dynamically stored in the RAM 915. The processor 905 reads instructions from the RAM 915 and performs actions as instructed. According to one embodiment of the invention, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
categorize a plurality of data provider objects into one or more used data provider objects that are used in a report at a first instance and one or more unused data provider objects that are not used in the report at the first instance, wherein the plurality of data provider objects are part of a query;
create a modified query by excluding the unused data provider objects;
retrieve and store data of the used data provider objects in a local data source using the modified query; and
display the unused data provider objects such that the unused data provider objects are differentiated from the used data provider objects and can be selected for use in the report at a second instance.

2. The article of manufacture of claim 1, further comprising instructions which when executed by the computer further causes the computer to:
categorize the one or more used data provider objects into data provider objects requiring data from an external data source and data provider objects requiring metadata.

3. The article of manufacture of claim 2, wherein the instructions to create the modified query by excluding the unused data provider objects, comprises instructions to:
create the modified query by excluding the unused data provider objects and the data provider objects requiring metadata.

4. The article of manufacture of claim 2, wherein the local data source includes metadata for one or more of the plurality of data provider objects.

5. The article of manufacture of claim 1, wherein the query is an un-editable initial query.

6. The article of manufacture of claim 1, wherein instructions to display the unused data provider objects such that the unused data provider objects are differentiated from the used data provider objects and can be selected for use in the report at the second instance, comprises instructions to:
highlight the unused data provider objects to differentiate the unused data provider objects from the used data provider objects.

7. The article of manufacture of claim 1, further comprising instructions which when executed by the computer further causes the computer to:
upon selection of one or more of the unused data provider objects, display values of one or more selected unused data provider objects as a dummy value; and
on a refresh operation, categorize the one or more selected unused data provider objects as used data provider objects that are used in the report at the second instance.

8. A computerized method for optimizing queries, the method comprising:
categorizing a plurality of data provider objects into one or more used data provider objects that are used in a report at a first instance and one or more unused data provider objects that are not used in the report at the first instance, wherein the plurality of data provider objects are part of a query;
creating a modified query by excluding the unused data provider objects;
retrieving and storing data of the used data provider objects in a local data source using the modified query; and
displaying the unused data provider objects such that the unused data provider objects are differentiated from the used data provider objects and can be selected for use in the report at a second instance.

9. The method of claim 8, further comprising:
categorizing the one or more used data provider objects into data provider objects requiring data from an external data source and data provider objects requiring metadata.

10. The method of claim 9, wherein creating the modified query, comprises:
creating the modified query by excluding the unused data provider objects and the data provider objects requiring metadata.

11. The method of claim 9, wherein the local data source includes metadata for one or more of the plurality of data provider objects.

12. The method of claim 8, wherein the query is an un-editable initial query.

13. The method of claim 8, wherein displaying the unused data provider objects such that the unused data provider objects are differentiated from the used data provider objects and can be selected for use in the report at the second instance, comprises:
highlighting the unused data provider objects to differentiate the unused data provider objects from the used data provider objects.

14. The method of claim 8, further comprising:
upon selection of one or more of the unused data provider objects, displaying values of one or more selected unused data provider objects as a dummy value; and
on a refresh operation, categorizing the one or more selected unused data provider objects as used data provider objects that are used in the report at the second instance.

15. A computer system for optimizing queries, comprising:
a computer memory to store program code; and
a processor to execute the program code to:
categorize a plurality of data provider objects into one or more used data provider objects that are used in a report at a first instance and one or more unused data provider objects that are not used in the report at the first instance, wherein the plurality of data provider objects are part of a query;
create a modified query by excluding the unused data provider objects;
retrieve and store data of the used data provider objects in a local data source using the modified query; and
display the unused data provider objects such that the unused data provider objects are differentiated from the used data provider objects and can be selected for use in the report at a second instance.

16. The system of claim 15, wherein the processor further executes the program code to:
categorize the one or more used data provider objects into data provider objects requiring data from an external data source and data provider objects requiring metadata.

17. The system of claim 16, wherein the program code to create the modified query by excluding the unused data provider objects, comprises program code to:
create the modified query by excluding the unused data provider objects and the data provider objects requiring metadata.

18. The system of claim 16, wherein the local data source includes metadata for one or more of the plurality of data provider objects.

19. The system of claim 16, wherein the query is an un-editable initial query.

20. The system of claim 16, wherein the program code to display the unused data provider objects such that the unused data provider objects are differentiated from the used data provider objects, comprises program code to:
highlight the unused data provider objects to differentiate the unused data provider objects from the used data provider objects.

21. The system of claim 16, wherein the processor further executes the program code to:
upon selection of one or more of the unused data provider objects, display values of one or more selected unused data provider objects as a dummy value; and
on a refresh operation, categorize the one or more selected unused data provider objects as used data provider objects that are used in the report at the second instance.
